(19) United States
(12) Patent Application Publication
(10) Pub. No.: US 2004/0215810 A1
(43) Pub. Date: Oct. 28, 2004

(54) Data synchronization method, data synchronization system and data synchronization program

(75) Inventors: Yasuo Tan, Ishikawa (JP); Takeshi Tsuchiya, Ishikawa (JP); Hitoshi Yamauchi, Kawasaki (JP); Ryuichi Matsukura, Kawasaki (JP)

Correspondence Address: STAAS & HALSEY LLP, SUITE 700, 1201 NEW YORK AVENUE, N.W., WASHINGTON, DC, 20005, US

(73) Assignees: JAPAN ADVANCED INSTITUTE OF SCIENCE AND TECHNOLOGY, Ishikawa (JP); FUJITSU LIMITED, Kawasaki (JP)

(21) Appl. No.: 10/798,262

(22) Filed: Mar. 12, 2004

(30) Foreign Application Priority Data
Apr. 14, 2003 (JP) 2003-109492

(51) Int. Cl. G06F 15/16

(52) U.S. Cl. 709/232

(57) ABSTRACT

The invention provides methods for synchronizing a plurality of data flows. In a first method, packets included in a plurality of data flows are sent out in the order of their generation times. A synchronization node adjusts the sending intervals of the packets such that they are the same as the generation intervals of the packets. In a second method, there are different synchronization nodes playing the different roles of sender-side synchronization node and receiver-side synchronization node. A receiver-side synchronization node receives a plurality of data flows from a sending device, and merges those packets in the data flows that have the same generation time into one packet. The merged packets are sent to a sender-side synchronization node, disassembled and restored to the original data flows. The restored data flows are sent by the sender-side synchronization node to their respective destinations.

### FIELD OF THE INVENTION

The present invention relates to technology for exchanging multimedia data over a plurality of communication lines between a plurality of communication terminals connected over a network, in which received data is output while synchronizing the communication lines.

The multimedia data may be data of any type and format, such as audio data, image data, text data, haptic data or olfactory data.

### BACKGROUND ART

The following is an example of communication by which audio data and image data are exchanged in real-time over a network. It takes some time after the sending terminal has sent out the packets constituting the data flow until those packets arrive at the receiving terminal. This delay is referred to as “network delay.” For different communication routes or different levels of congestion of the network on the communication route, also the network delay will differ for each data flow. Thus, if a plurality of data flows are sent from the same sending terminal to the same receiving terminal, the network delay will be different for each data flow.

For example, let us consider the case that terminals TA, TB and TC are operated by users A, B and C, and the receiving terminal TA simultaneously receives audio data flows #b and #c from the sending terminals TB and TC. Even though user B may have started to talk prior to user C, the network delays may cause the problem that the voice of user C is output first at the receiving terminal A, before the voice of user B is output.

As an approach for countering the problem of synchronization caused by the difference in network delays, JP H9-219851A proposes a method for sending the plurality the data of a plurality of types to be synchronized together in capsules. On the sending side, by sending the audio packets and the image packets in association with a sequence number, the audio data and the video data are sent out as one in capsules. At the receiving terminal, the capsuled compound data are disassembled, the audio data and the image data are retrieved, and output respectively over a speaker and on a display. By sending data of a plurality of types in association with a sequence number, it becomes possible to synchronize the audio data and the image data at a single receiving terminal.

JP H7-95242A proposes providing a video conference server that receives and aggregates the packets included in the data flow from each user terminal with a synchronization function. This video conference server references a sequence number marking the packet of the video data flow from each user terminal, and merges the video data with the same sequence number. Moreover, the server receives the audio packets from the user terminals and generates mixed audio data with the same method. The user terminal receiving the merged video data and the mixed audio data outputs the merged video and mixed audio on a display and a speaker.

### SUMMARY OF THE INVENTION

In recent years, there have been advances in the networking of a large variety of appliances, such as information appliances. Also, the information that is entered and given out has gone beyond visual information, such as text data and image data, and auditory information, such as audio data, and now includes haptic data expressing touch and olfactory data expressing smells. Therefore, a large variety of input devices and output devices, which can be directly connected to a network, can be anticipated. Thus, multimedia data flows of a plurality of types can be entered and sent or received and output with such network devices. As such devices become popular, one can anticipate a need for outputting different video data flows in synchronization on a plurality of displays or projectors that are set up in one room, for example. Or, one can anticipate a need for outputting a plurality of audio data flows in synchronization on a plurality of speakers. Moreover, one can anticipate a need for synchronizing the output of a display or a projector with that of a speaker.

Currently, systems are being tested, in which users that are at different locations create a shared virtual space on a network and undertake some common activity in that virtual space. Specific examples of this are trial systems, operating in virtual space, of teams of physicians who are at a remote location performing a remote medical treatment of collaborative medical diagnosis or surgery, as well remote education or remote collaboration designs. In remote medical treatment, trials are run in which the physicians not only can see each other's faces and bodies and hear each other's voices, but also can share other data in real time, so that the physicians can undertake a common operation in real time. More specifically, examples of data that can be shared include animated data of the simulated blood flow, dynamically changing 3D object data of the organism or the like, or haptic data expressing touch.

Such a virtual space can be constructed by combining terminals exchanging, in real time, changes of the various elements constituting the virtual space and output devices for the various kinds of multimedia data. Moreover, in order to realize a smooth common remote operation, the various kinds of multimedia data must be synchronized and restored on the receiving terminals in the correct order. If there is not only one but a plurality of receiving terminals, then a scheme for synchronizing the multimedia data on the plurality of receiving terminals is necessary.

In the related art discussed above, a plurality of data flows are received on one receiving terminal, and output on an output device. If, for example, a synchronization process is carried out on the receiving terminal, then the video output on the display and the audio output on the speaker connected to this receiving terminal can be synchronized. However, there have been no proposals regarding the synchronization of data on different receiving terminals if a plurality of data flows are received with different receiving terminals. Moreover, since the synchronization process is presumed to be taking place on the side of the receiving terminal, there is the problem that the load due to the synchronization process cannot be taken from receiving terminals with insufficient processing capacity. Therefore, the technology presented in the related art cannot satisfy the above-described needs.

It is thus an object of the present invention to enable the synchronization of the output of the data flows on receiving terminals in the case that the receiving terminals receive different data flows.

Moreover, it is an object of the present invention to remove the load of the synchronization process from the receiving terminals.

According to a first aspect of the present invention, a data synchronization method performed by a computer relaying a plurality of data flows between a plurality of networks includes:

a storing step of storing identifiers of a plurality of data flows to be synchronized;

a receiving step of receiving data flows flowing on at least one of the networks;

a selecting step of selecting, from the received data flows, a plurality of the data flows stored in the storing step;

a calculating step of calculating times when the packets included in the selected data flows have been generated by one or more sending terminals that have sent the selected data flows;

an order determining step of determining, in accordance with the calculated generation times, an order in which the packets included in the selected data flows are sent to one or more receiving terminals that are the destinations of the selected data flows;

a sending time determining step of determining the sending times of the packets included in the selected data flows, such that intervals between the sending times of the packets are equivalent to intervals between the generation times of the packets and the packets are sent in accordance with said order; and

a sending step of sending the packets to the one or more receiving terminals, based on the sending times.

Conceivable are two data flows that are sent from sending terminals on a first network via a relaying device to receiving terminals on a second network. The relaying device rearranges the packets included in the data flows in the order in which they have been generated, and sends them to the receiving terminals. Consequently, the problem is solved that the arrival order of the packets differs from their generation order because the network delays differ for each data flow. Moreover, the sending intervals of packets sent from the relaying device to the receiving terminals is adjusted such that they are the same as the generation intervals of the packets. Consequently, a synchronization process does not have to be performed on the receiving terminal side. If there are a plurality of receiving terminals, then the output results will be synchronized among the receiving terminals even if the data flows are received by the receiving terminals and output as is to output devices.

According to a second aspect of the present invention, in the storing step, a screen for entering settings of the identifiers of the plurality of data flows to be synchronized is displayed, and the identifiers entered in that screen are stored.

According to a third aspect of the present invention,

in the selecting step, a plurality of data flows made of packets are selected, which include packets specifying time data related to times at which the one or more sending terminals sending the data flows have generated the packets; and

in the calculating step, the generation times of the packets are calculated based on the time data.

For example, a timestamp is specified as the generation time in the RTP packets. And a timestamp having the same value as that of the RTP packet as well as the absolute time at which the RTCP packet was generated are specified in the RTCP packets sent from the sending terminals. Using this information, it is possible to calculate the generation time of the RTP packets.

According to a fourth aspect of the present invention, in the sending step:

the packet sending times and the packets are temporarily stored in association with each other;

it is judged at a predetermined timing whether there are temporarily stored packets whose sending time has been exceeded; and

the packets whose sending times has been exceeded are sent out.

According to a fifth aspect of the present invention,

the synchronization method further comprises a buffering step of temporarily storing packets included in the data flows selected in the selecting step;

wherein the calculating step calculates the generation times based on an absolute time and a timestamp specified in an RTCP packet included in the selected data flow as well as a timestamp included in an RTP packet; and

wherein the sending time determining step determines a reference time T0 for determining the sending times based on a time T_{rtcp} at which the first RTCP packet has arrived from one of the sending terminals and a maximum time Tₘₐₓ for which packets can be stored in the buffering step.

The sending times are determined by adding the generation interval of the packets to the reference time T0. The reference time T0 can be determined using the following equation:

T0=T_{rtcp}+Tₘₐₓ

Here, T_{rtcp} is the time at which the first RTCP packet has arrived. Tₘₐₓ is the maximum time that packets can be buffered.

According to a sixth aspect of the present invention, the data synchronization method further comprises a buffering step of temporarily storing packets included in the data flows selected in the selecting step;

wherein the calculating step calculates the generation times based on an absolute time and a timestamp specified in an RTCP packet included in the selected data flow as well as a timestamp included in an RTP packet; and

wherein the sending time determining step determines a reference time T0 for determining the sending times based on a time T_{rtcp} at which the first RTCP packet has arrived from one of the sending terminals and a time Tb that is necessary to store a predetermined amount of packets in the buffering step.

The sending times are determined by adding the generation interval of the packets to the reference time T0. The reference time T0 can be determined using the following equation:

T0=T_{rtcp}+T_{b}

Here, T_{rtcp} is the time at which the first RTCP packet has arrived. T_{b} is the time that is necessary to store, for example, an amount of half of the packets that can be buffered.

According to a seventh aspect of the present invention, a data synchronization system relaying a plurality of data flows between a plurality of networks, comprises:

a storing means for storing identifiers of a plurality of data flows to be synchronized;

a receiving means for receiving data flows flowing on at least one of the networks;

a selecting step of selecting, from the received data flows, a plurality of the data flows stored by the storing means;

a calculating means for calculating times when the packets included in the selected data flows have been generated by one or more sending terminals that have sent the selected data flows;

an order determining means for determining, in accordance with the calculated generation times, an order in which the packets included in the selected data flows are sent to one or more receiving terminals that are the destinations of the selected data flows;

a sending time determining means for determining the sending times of the packets included in the selected data flows, such that intervals between the sending times of the packets are equivalent to intervals between the generation times of the packets and the packets are sent in accordance with said order; and

a sending means for sending the packets to the one or more receiving terminals, based on the sending times.

According to an eighth aspect of the present invention, a data synchronization program executed on a computer relaying a plurality of data flows between a plurality of networks comprises:

a storing step of storing identifiers of a plurality of data flows to be synchronized;

a receiving step of receiving data flows flowing on at least one of the networks;

a selecting step of selecting, from the received data flows, a plurality of the data flows stored in the storing step;

a calculating step of calculating times when the packets included in the selected data flows have been generated by one or more sending terminals that have sent the selected data flows;

an order determining step of determining, in accordance with the calculated generation times, an order in which the packets included in the selected data flows are sent to one or more receiving terminals that are the destinations of the selected data flows;

a sending time determining step of determining the sending times of the packets included in the selected data flows, such that intervals between the sending times of the packets are equivalent to intervals between the generation times of the packets and the packets are sent in accordance with said order; and

a sending step of sending the packets to the one or more receiving terminals, based on the sending times.

Also computer-readable recording media storing such a program are included in the scope of the present invention. Examples of such recording media include computer-readable flexible disks, hard-disks, semiconductor memories, CD-ROMs, DVDs and magneto-optical disks (MOs), among others.

According to a ninth aspect of the present invention, a data synchronization method performed by a computer relaying a plurality of data flows between a plurality of networks comprises:

a receiving step of receiving, from at least one of the networks, a plurality of data flows made of packets, including packets specifying times at which one or more sending terminals sending the data flows have generated the packets;

a storing step of storing identifiers of a plurality of data flows to be synchronized, and a relay address of a relaying device relaying the plurality of data flows;

a selecting step of selecting, from the data flows received in the receiving step, a plurality of the data flows stored in the storing step;

a merging step of generating a merged packet in which those packets in the selected data flows that have the same generation time have been merged into one packet; and

a sending step of sending the merged packet to the relay address.

Conceivable is a synchronization system in which a first relaying device merges a plurality of data flows from sending terminals on a first network to receiving terminals on a second network, and a second relaying device separates those data flows. The data synchronization method according to this aspect of the present invention is executed by the first relaying device. The data flows are sent by RTP (Real Time Protocol), for example. Identifiers of the two data flows that are synchronized are stored beforehand in the first relaying device. The first relaying device merges, of the packets P₁₋ᵢ, P₂₋ⱼ included in the two data flows, those packets P₁₋ₘ, P₂₋ₘ that have the same generation time, an generates one merged packet Pm. The merged data flow made of the merged packets Pm is sent from the first relaying device to the second relaying device, and disassembled into the respective data flows. It should be noted that it is preferable that the synchronized data flows have the same payload type.

According to a tenth aspect of the present invention, in the storing step, a screen for entering settings of identifiers of the plurality of data flows to be synchronized and the relay address of the relaying device is displayed, and the identifiers and the relay address entered in that screen are stored.

According to an eleventh aspect of the present invention,

the storing step further stores a payload type of the respective data flows; and

the merging step merges those packets in the selected data flows that have the same payload type into one packet.

According to a twelfth aspect of the present invention, a data synchronization system relaying a plurality of data flows between a plurality of networks, comprises:

a receiving means for receiving, from at least one of the networks, a plurality of data flows made of packets, including packets specifying times at which one or more sending terminals sending the data flows have generated the packets;

a storing means for storing identifiers of a plurality of data flows to be synchronized, and a relay address of a relaying device relaying the plurality of data flows;

a selecting means for selecting, from the data flows received with the receiving means, a plurality of the data flows stored by the storing means;

a merging means for generating a merged packet in which those packets in the selected data flows that have the same generation time have been merged into one packet; and

a sending means for sending the merged packet to the relay address.

According to a thirteenth aspect of the present invention, a data synchronization program executed by a computer relaying a plurality of data flows between a plurality of networks, comprises:

a receiving step of receiving, from at least one of the networks, a plurality of data flows made of packets, including packets specifying times at which one or more sending terminals sending the data flows have generated the packets;

a storing step of storing identifiers of a plurality of data flows to be synchronized, and a relay address of a relaying device relaying the plurality of data flows;

a selecting step of selecting, from the data flows received in the receiving step, a plurality of the data flows stored in the storing step;

a merging step of generating a merged packet in which those packets in the selected data flows that have the same generation time have been merged into one packet; and

a sending step of sending the merged packet to the relay address.

Also computer-readable recording media storing such a program are included in the scope of the present invention.

According to a fourteenth aspect of the present invention, a data synchronization method performed by a computer relaying a plurality of data flows between a plurality of networks, comprises:

a receiving step of receiving, from at least one of the networks, a merged packet generated by the method according to claim 9;

a storing step of storing the destination addresses of the data flows included in the merged data flow including the merged packet;

a disassembling step of disassembling the merged packet and restoring the plurality of data flows; and

a sending step of sending the restored plurality of data flows to their respective destination addresses.

Conceivable is a synchronization system in which a first relaying device merges a plurality of data flows sent from the sending terminals on the first network to the receiving terminals on the second network and a second relaying device separates the data flows. The data synchronization method of the foregoing aspect of the present invention executes the second relaying device. The second relaying device disassembles the merged packets created by the first relaying device and restores the original data flows. The restored data flows are sent to the destinations of the respective data flows. Thus, the receiving devices can receive a plurality of data flows in synchronized form without carrying out a synchronization process on those receiving devices. Moreover, if there is a plurality of receiving devices, the output of output devices connected to the receiving devices can be synchronized. It should be noted that it is preferable that the synchronized data flows have the same payload type.

According to a fifteenth aspect of the present invention, in the storing step, a screen for entering settings of identifiers of a receiver location of the merged data flow and the respective destination addresses of the data flows is displayed, and the identifier and destination addresses entered in that screen are stored.

According to a sixteenth aspect of the present invention, a data synchronization system relaying a plurality of data flows between a plurality of networks comprises:

a receiving means for receiving, from at least one of the networks, a merged packet generated by the method according to claim 9;

a storing means for storing the destination addresses of the data flows included in the merged data flow including the merged packet;

a disassembling means for disassembling the merged packet and restoring the plurality of data flows; and

a sending means for sending the restored plurality of data flows to their respective destination addresses.

According to a seventeenth aspect of the present invention, a data synchronization program executed by a computer relaying a plurality of data flows between a plurality of networks comprises:

a receiving step of receiving, from at least one of the networks, a merged packet generated by the method according to claim 9;

a storing step of storing the destination addresses of the data flows included in the merged data flow including the merged packet;

a disassembling step of disassembling the merged packet and restoring the plurality of data flows; and

a sending step of sending the restored plurality of data flows to their respective destination addresses.

Also computer-readable recording media storing such a program are included in the scope of the present invention.

With the present invention, the load of the synchronization process can be taken away from the receiving terminals receiving a plurality of data flows. Moreover, if a plurality of receiving terminals receive different data flows, then the output from the receiving terminals can be synchronized without performing a synchronization process on the receiving terminal side.

### BRIEF DESCRIPTION OF THE DRAWINGS

FIG. 1 is a diagram showing the overall configuration of a synchronization system according to a first embodiment.

FIG. 2 is a functional block diagram of the synchronization device in FIG. 1.

FIG. 3 is a diagrammatic view of the settings file in the synchronization device in FIG. 1.

FIG. 4 is a first diagram showing an example of a group selection screen for storing a flow group in the settings file.

FIG. 5 is a second diagram showing an example of a group selection screen for storing a flow group in the settings file.

FIG. 6 is a diagrammatic view of the monitoring table in the synchronization device in FIG. 1.

FIG. 7 is a diagram illustrating the structure of ether frames.

FIG. 8 is a diagram showing the configuration of an IP packet.

FIG. 9 is a diagram showing the configuration of an UDP packet.

FIG. 10A is a diagram showing the configuration of an RTP packet.

FIG. 10B is a diagram showing the configuration of an RTCP packet.

FIG. 11 is a diagram illustrating a method for calculating the generation time of a packet.

FIG. 12 is a diagram illustrating the relation between the generation timing of packets and the sending timing of packets in a synchronized data flow.

FIG. 13A is a diagrammatic view of a buffer in which packets and the order of their generation times are stored.

FIG. 13B is a diagrammatic view of a buffer in which the packets are associated with their sending times.

FIG. 14 is a flowchart showing an example of the flow of the synchronization process performed by the synchronization device in FIG. 2.

FIG. 15 is a diagram showing the overall configuration of a synchronization system according to a second embodiment.

FIG. 16 is a functional block diagram of the synchronization device in FIG. 15.

FIG. 17 is a diagrammatic view of the settings file in the synchronization device of FIG. 15.

FIG. 18 is a first diagram showing an example of a group selection screen for storing a flow group in the settings file of FIG. 17.

FIG. 19 is a second diagram showing an example of a group selection screen for storing a flow group in the settings file of FIG. 17.

FIG. 20 is a diagram showing the configuration of a merged packet.

FIG. 21 is a flowchart showing an example of the flow of the synchronization process performed by the synchronization device in FIG. 16.

### DESCRIPTION OF THE PREFERRED EMBODIMENTS

### Outline of the Invention

In accordance with one embodiment of the present invention, a plurality of data flows are sent to a receiving device after synchronization by a computer (referred to as “synchronization node” below) that relays data flows from a sending device to a receiving device. There are broadly speaking two data synchronization methods performed by the synchronization node.

Data Synchronization Method 1: The packets included in the plurality of data flows are sent out in the temporal order in which they are generated. The synchronization node adjusts the sending intervals of the packets such that they become the same as the generation intervals of the packets. Data Synchronization Method 1 is explained in detail in a first embodiment.

Data Synchronization Method 2: There are different synchronization nodes playing the different roles of sender-side synchronization node and receiver-side synchronization node. A receiver-side synchronization node receives a plurality of data flows from a sending device, and merges those packets in the data flows that have the same generation time into one packet. The merged packets are sent to a sender-side synchronization node, disassembled and restored to the original data flows. The restored data flows are sent by the sender-side synchronization node to their respective destinations. Data Synchronization Method 2 is explained in detail in a second embodiment.

### First Embodiment

(1) Overall Configuration

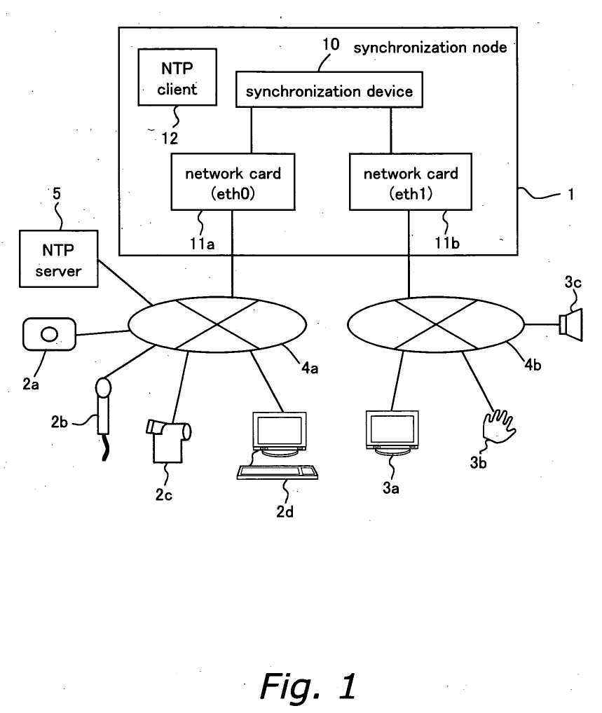

FIG. 1 is a diagram showing the overall configuration of a synchronization system using a synchronization device according to a first embodiment. A synchronization device 10 is provided in a synchronization node 1 that relays data flows between a plurality of networks 4a and 4b. The synchronization node 1 can be connected to the networks 4a and 4b by a plurality of network cards 11a and 11b. The synchronization device 10 synchronizes the plurality of data flows sent out from one or more sending terminals 2a to 2d (in the following referred to as “sending terminals 2”) on the network 4a, and sends them to one or more receiving terminals 3a to 3d (in the following referred to as “receiving terminals 3”) on the network 4b. Examples of the sending terminals 2 are sending terminals 2a and 2c that are connected to or incorporate an image input device, such as a still camera or a video camera, a sending terminal 2b that is connected to or incorporates an audio input device, such as a microphone, and a sending terminal 2d that is connected to or incorporates a text data input device, such as a keyboard. Other examples are sending terminals that send haptic data or olfactory data. Examples of receiving terminals 3 are a receiving terminal 3a that is connected to or incorporates an image output device, such as a liquid crystal display, a receiving terminal 3b that is connected to or incorporates an output device for haptic data, and a receiving terminal 3c that is connected to or incorporates an audio output device, such as a speaker.

An NTP (network time protocol) server 5 is connected to one of the networks 4 (network 4a in FIG. 1). The synchronization node 1, the sending terminals 2 and the receiving terminals 3 are each provided with an NTP client 12. The NTP clients of the sending terminals 2 and the receiving terminals 3 are not shown in the figures. The NTP server and the NTP clients correct discrepancies between the internal clocks of the synchronization node 1, the sending terminals 2 and the receiving terminals 3.

In the following, in order to facilitate explanations, an example is described in which the sending terminals 2 are on the network 4a and the receiving terminals 3 are on the network 4b. It should be noted, however, that the network 4 on which the sending terminals 2 and the receiving terminals 3 are located is not limited to one or the other. FIG. 1 shows the case that there are a plurality of sending terminals 2 and a plurality of receiving terminals 3, but the present invention can also be applied to the case that there is only one sending terminal 2 and/or only one receiving terminal 3. Moreover, the plurality of data flows may be sent out from one sending terminal 2 or from a plurality of sending terminals 2. Similarly, the plurality of data flows may be sent to one receiving terminal 3 or to a plurality of receiving terminals 3.

(2) Synchronization Device

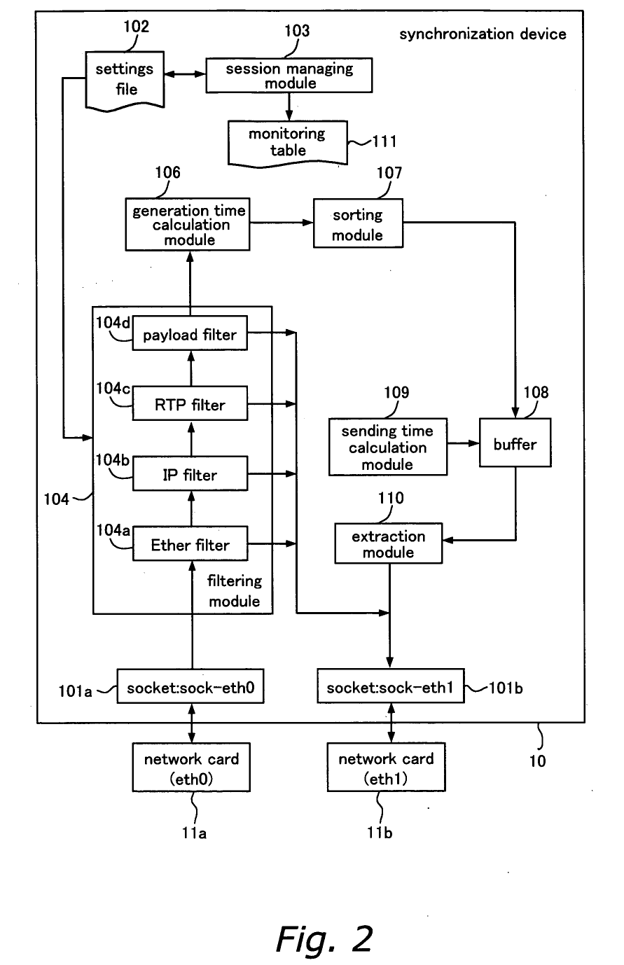

FIG. 2 is a functional block diagram of the synchronization device 10 provided in the synchronization node 1. The synchronization device 10 receives a plurality of data flows from the sending terminals 2 via the network card 11a. After the synchronization device 10 has synchronized the data flows, it sends them via the network card 11b to each of the receiving terminals 3. It should be noted that if the network 4b is the sender-side network and the network 4a is the receiver-side network, then the network card 11b receives the data flows and the network card 11a sends the data flows.

The various blocks function as follows. All packets flowing on the network 4a arrive at the receiver-side network card 11a. All the packets that have arrived at the network card 11a are supplied through a raw socket 101a to a filtering module 104. The data flows to be synchronized are listed beforehand in a settings file 102 (see (2-1) “Settings of Data Flows to be Synchronized” below). The filtering module 104 looks up the settings file 102, selects only the packets that are part of the data flows to be synchronized, and passes them on to a generation time calculation module 106 (see (2-3) “Selection of Data Flows to be Synchronized” below). The generation time calculation module 106 calculates the time when the packets of the data flows to be synchronized have been generated at the sending terminal 2 (see (2-4) “Calculation of Generation Time of the Packets” below). The packets whose generation time has been calculated are sorted by a sorting module 107 in the order of their generation times, and are stored in a buffer 108. Then, the sending time of the packets is calculated by a sending time calculation module 109 (see (2-5) “Calculation of Sending Time of Packets” below). The sending time of the packets is determined such that the generation time interval and the sending time interval of each of the packets become the same. The sending time of each of the packets is stored in the buffer 108, in association with each packet. The sending times interval stored in the buffer 108 are looked up at predetermined times by an extraction module 110, and packets whose sending time has already passed at the time of the lookup are sent via a raw socket 101b and the network card 11b to the receiving terminal 3. The raw sockets 101a and 101b, which allow transfer of all ports and data by IP (Internet Protocol) communication, are generated by the synchronization device 10 when the synchronization node 1 is started up, for example.

(2-1) Settings of Data Flows to be Synchronized

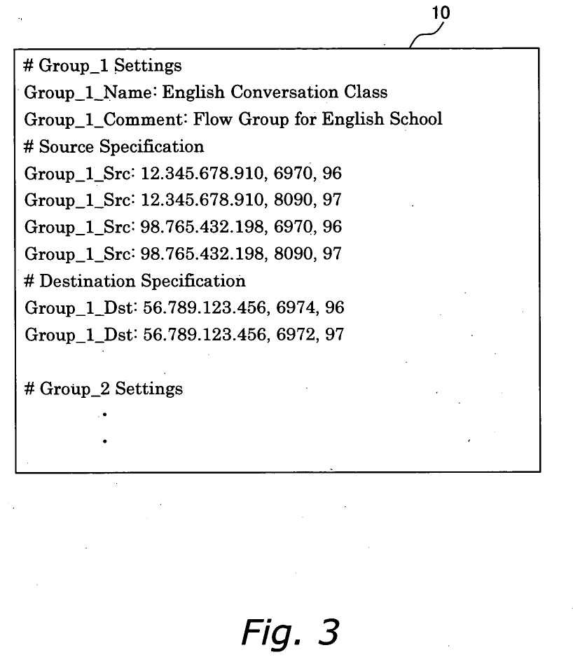

The following is a more detailed explanation of the function of each block. FIG. 3 is a diagrammatic view of the group specification data listed in the settings file 102. The settings file 102 lists which data flows are to be synchronized, that is, it specifies the data flows to be synchronized. The settings file 102 also lists the various destinations of the synchronized data flows. The data flows to be synchronized form one flow group. In the example in FIG. 3, the following group specification data (a) to (d) are specified in the settings file:

(a) “group name” of the flow group

(b) “comments” regarding the group

(c) IP address, port number and data flow payload type of the sending terminals sending the data flow

(d) IP address, port number and data flow payload type of the receiving terminals receiving the data flow

The group specification data may be similarly set not only for one flow group, but also for a plurality of flow groups.

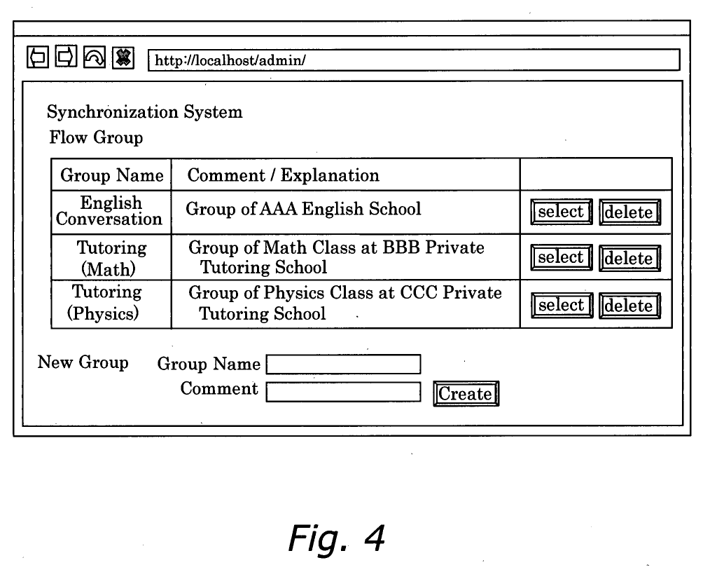

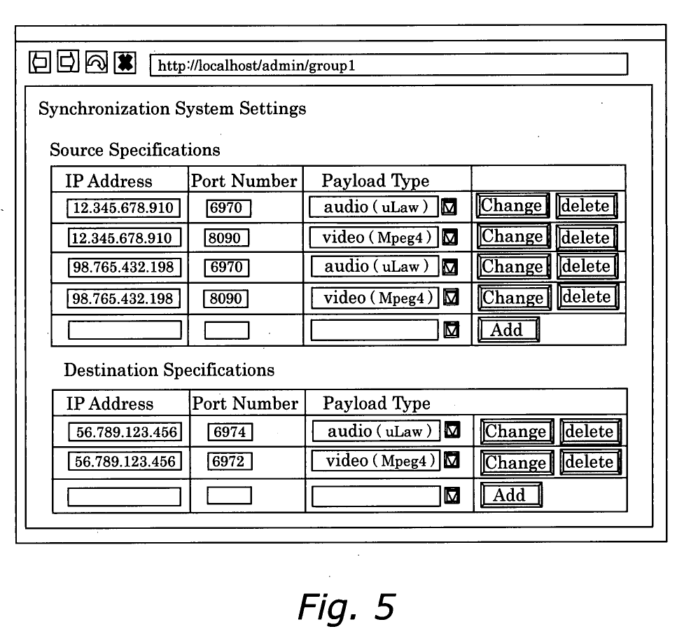

FIGS. 4 and 5 are examples of screens displayed when storing the group specification data to the settings file 102. These screen examples are displayed by a session managing module 103 on a screen of a display connected to the synchronization node 1. The information that is input is written into the settings file 102. FIG. 4 is an example of a group selection screen for setting a flow group. In this screen the settings regarding the group name of the flow group and the comments are entered. FIG. 5 is an example of a screen for setting the flows to be synchronized. In this screen, the senders and the destinations of the data flows to be included in the same flow group are specified.

(2-2) Monitoring Beginning and End of Communication

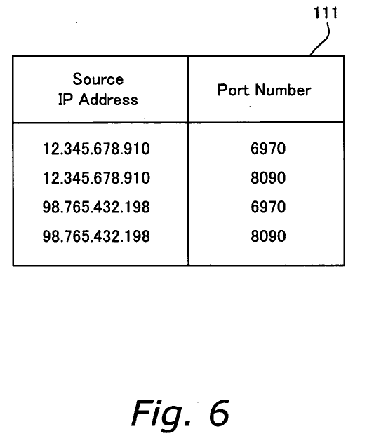

FIG. 6 is a diagrammatic view of a monitoring table 111. The generation of this table and the writing into this table are carried out by the session managing module 103. The monitoring table 111 is for monitoring the beginning and the end of the communication by the data flows synchronized by the synchronization device 10. The source IP address and its port number are written into the synchronization table 111 when communication by a data flow to be synchronized begins. When the communication by this data flow ends, the entry of this data flow is deleted from the monitoring table 111.

(2-3) Selection of Data Flows to be Synchronized

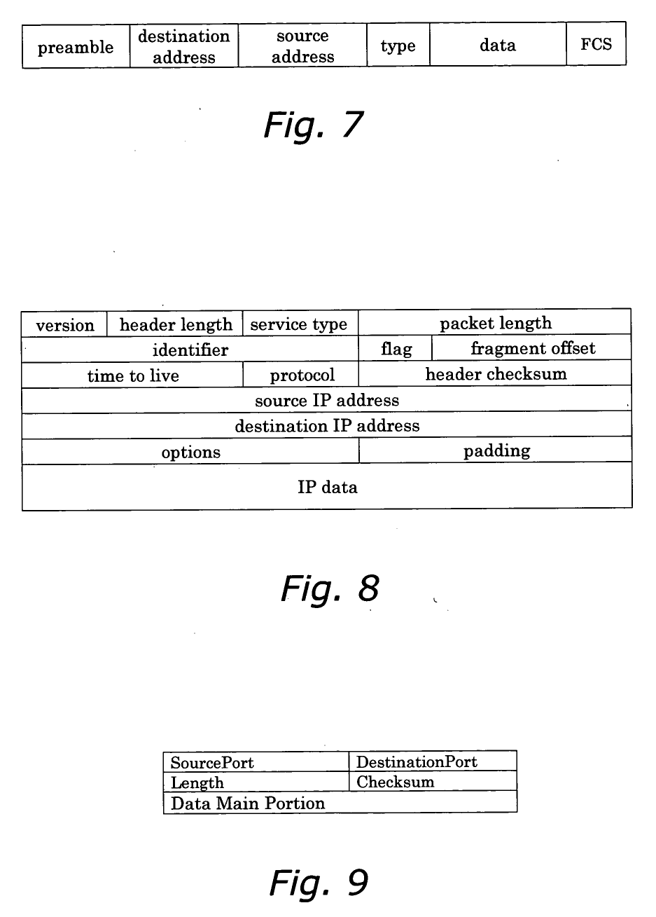

FIGS. 7 to 10 are diagrams illustrating the function of the filtering module 104. In the example given here to explain the filtering module 104, the data flows to be synchronized are sent based on RTP (Real-time Transport Protocol). The filtering module 104 includes an ether filter 104a, an IP filter 104b, an RTP filter 104c and a payload filter 104d. The following is an explanation of the function of each of those filters.

The ether filter 104a receives from the raw socket 101a all packets flowing on the network 4a, selects the ether frames including IP packets and supplies them to the IP filter 104b. The other ether frames are sent out via the raw socket 101b to the receiver-side network 4b. The classification of the ether frames is carried out by looking up the type field included in the ether header in the ether frames as shown in FIG. 7.

The IP filter 104b discriminates the ether frames including UDP (User Datagram Protocol) packets from the ether frames including IP packets. The IP filter 104b also discriminates from the ether frames including UDP packets those ether frames that are included in the data flows to be synchronized, and supplies those ether frames to the RTP filter 104c. The other ether frames are sent via the raw socket 101b to the receiver-side network 4b. The discrimination of the ether frames including UDP packets is performed by looking up the protocol field included in the IP header of the IP packet as shown in FIG. 8. The discrimination of the data flows to be synchronized is performed by comparing the source address and the destination address of the IP header with the group specification data in the settings file 102.

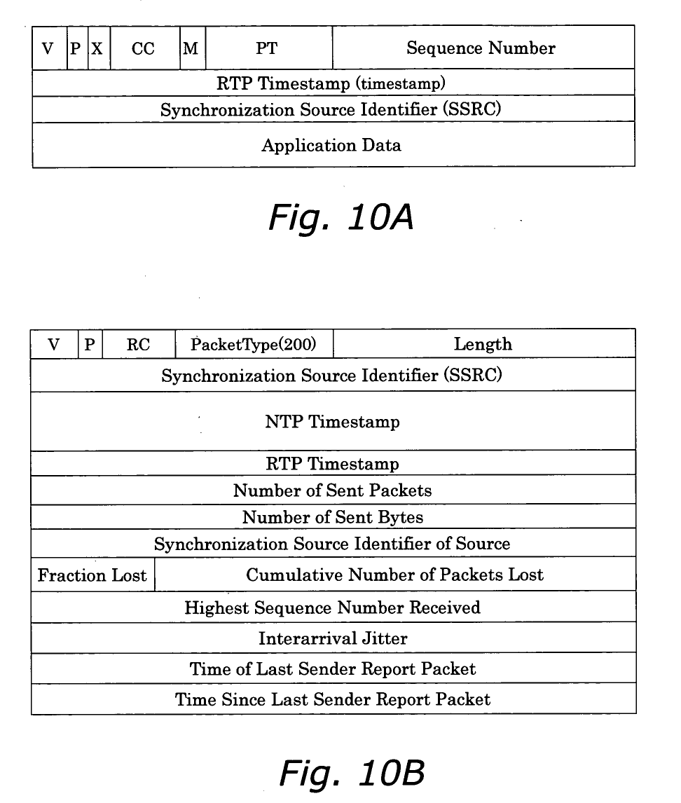

The RTP filter 104c discriminates the ether frames including RTP packets or RTCP (RTP Control Protocol) packets from the either frames including UDP packets and supplies the discriminated ether frames to the payload filter 104d. The other ether frames are sent via the raw socket 101b to the receiver-side network 4b. The discrimination of the ether frames is performed by discriminating RTP packets and RTCP packets based on the port number in the UDP header. Ordinarily, “RTP port number+1” is used for the RTCP port number. It is also possible to discriminate the packets in which the value of the version number “V” in the RTP and RTCP headers is “2”. FIG. 9 shows the configuration of a UDP packet. FIG. 10A shows the configuration of an RTP packet, and FIG. 10B shows the configuration of an RTCP packet.

The payload filter 104d discriminates, from the ether frames including RTP packets or RTCP packets, those ether frames that include the same payload type as the data flows to be synchronized. The discriminated ether frames are passed to the generation time calculation module 106. The ether frames having a payload type that is different from that of the data flows to be synchronized are sent via the raw socket 101b to the receiver-side network 4b. This discrimination is carried out by comparing the payload type (“PT” in the figures) included in the RTP packets with the payload type of the data flows to be synchronized in the settings file 102. Of the data flows to be synchronized that are listed in the settings file 102, the data flows to be compared are those of the payload type of the data flows to be synchronized where the source IP address and the destination IP address in the IP header match.

(2-4) Calculation of Generation Time of Packets

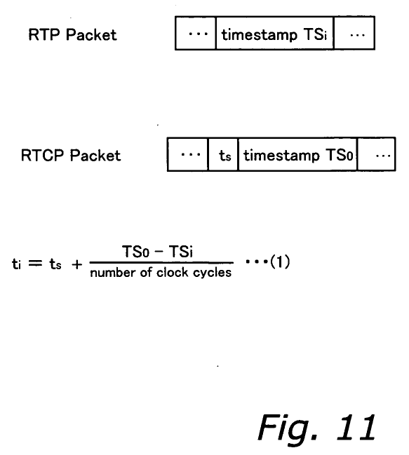

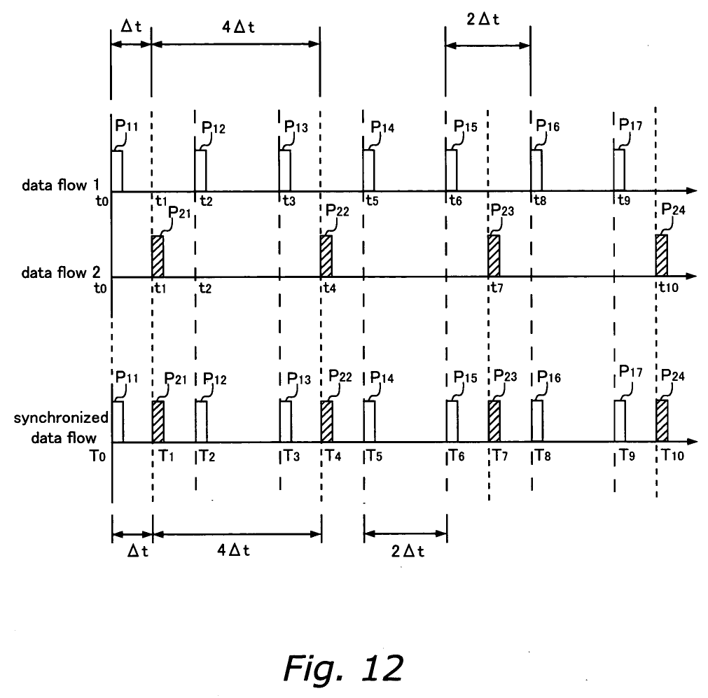

FIGS. 11 and 12 are diagrams illustrating the function with which the generation time calculation module 106 calculates the generation time of the packets. The generation time calculation module 106 calculates the time at which the IP packets included in the data flow to be synchronized have been generated by the sender terminals 2. For the calculation of the generation time, the timestamp included in the RTP packets, as well as the timestamp and the NTP timestamp included in the RTCP packets are used. The generation time ti of any RTP packet can be expressed by Equation (1) in FIG. 11. Here, TSi is the value of the timestamp in the RTP packet, TSO is the value of the timestamp in the RTCP packet, and ts is the NTP time in that RTCP packet.

That is to say, the generation time of an RTP packet is equal to the difference between the timestamp of the RTP packet and the timestamp of the RTCP packet divided by the number of clock cycles plus the NTP time of the RTCP packet. Based on the generation time ti calculated in this manner, the ether frames included in the data flows to be synchronized are stored in the buffer 108 in the order of the generation time of the RTP packets. This rearranging in the order of the generation time and the storing in the buffer 108 is performed by the sorting module 107. Here, “clock cycle” means a predetermined period that depends on the payload type, and is the frequency of the clock that is incremented automatically for each data flow. In the case of an audio data flow, the clock frequency is 8000 Hz, and a counter advancing at a speed of 8000 per second is incremented for each data flow. The counter value at the RTP packet generation time is set as the timestamp value in the RTP header.

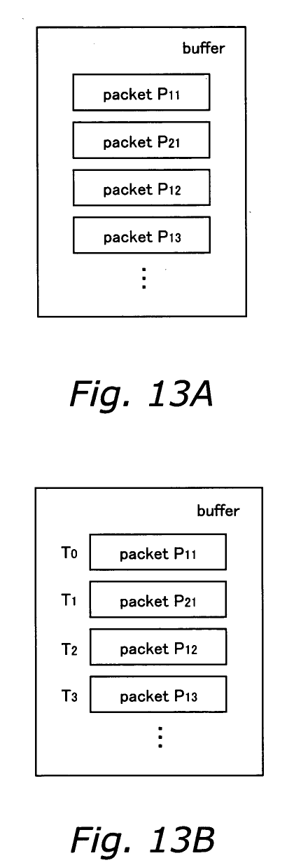

FIGS. 12 and 13(A) are diagrams illustrating the function of the sorting module 107. For example, let us assume that data flows 1 and 2 have been sent out in packets in the order and with the intervals shown in FIG. 12. Here, the packets P11(t0), P12(t2), P13(t3) . . . are RTP packets included in the data flow 1 and their generation times. The packets P21(t1), P22(t4), P23(t7) . . . are RTP packets included in the data flow 2 and their generation times. FIG. 13A shows how the ether frames including the packets of the data flows 1 and 2 are recorded in the buffer 108 in the order of the generation times ti.

(2-5) Calculation of the Sending Time of Each Packet

Referring to FIGS. 12 and 13(B), the following is an explanation of the calculation of the sending time of each of the ether frames. The sending times are calculated by the sending time calculation module 109. The sending times of the ether frames recorded in the buffer 108 are determined such that they are in the order of the generation times of the RTP packets included therein. Moreover, the sending times of the ether frames are determined such that the sending intervals of the RTP packets included therein becomes the same as the generation intervals of the RTP packets. More specifically, the sending times are determined such that the following conditions are satisfied:

(i) the generation intervals between the packets in the same data flow are preserved;

(ii) the generation intervals between the packets of different data flows are preserved.

This is explained in more detail with reference to FIG. 12. In FIG. 12, the packets of the data flow 1 are generated at intervals of 2Δt. The packets of the data flow 2 are generated at intervals of 4Δt. The generation interval between packets of the data flow 1 and the packets of the data flow 2 is always an offset of Δt. Consequently, in the example of FIG. 12, the sending times are calculated such that the following conditions are satisfied:

(i) The sending interval between the packets in the data flow 1 is 2Δt;

(ii) the sending interval between the packets in the data flow 2 is 4Δt;

(iii) the sending interval between the packets in the data flow 1 and the packets in the data flow 2 is Δt.

The actual sending times are determined by adding the sending intervals to a reference time T0. Explaining this with reference to FIG. 12, the sending times T0, T2, T3, T5, T6, . . . of the packets in the data flow 1 are given by the following equation:

T=T0+2Δt×(i−1)

wherein i is an integer of 1 or greater.

The sending times T1, T4, T7, T10, . . . of the packets in the data flow 2 are given by the following equation:

T=T0+Δt+4Δt×(i−1)

wherein i is an integer of 1 or greater.

The reference time T0 for determining the sending time can be determined for example as follows:

T0=T_{rtcp}+Tₘₐₓ (2)

Here, T_{rtcp} is the time at which the first ether frame of the data flows to be synchronized that includes an RTCP packet has arrived at the synchronization node 1. Tₘₐₓ is the maximum time that the ether frames are held in the buffer 108.

The reference time T0 may also be determined as follows:

T0=T_{rtcp}+Tb (3)

wherein T_{rtcp} is the time at which the first ether frame of the data flows to be synchronized that includes an RTCP packet has arrived at the synchronization node 1, and Tb is the time that is necessary to store a predetermined amount of ether frames in the buffer 108. More specifically, Tb may be the time that is necessary to store, for example, up to half the ether frames of the maximum amount that can be stored in the buffer 108.

It is also possible to set, for example, the smaller one of the values determined with Equations (2) and (3) as the reference time T0.

The sending time of each of the packets determined as described above is stored in the buffer 108 in association with the packets. FIG. 13B is a diagram showing how the ether frames including the IP packets and their sending times are associated and stored in the buffer 108. The sending times of the ether frames stored in the buffer 108 are looked up at predetermined timings by the extraction module 110. The ether frames including packets whose sending time has already been exceeded at that time are sent from the buffer 108 via the raw socket 101b to the receiver-side network 4b.

(3) The Process Flow Performed by the Synchronization Device

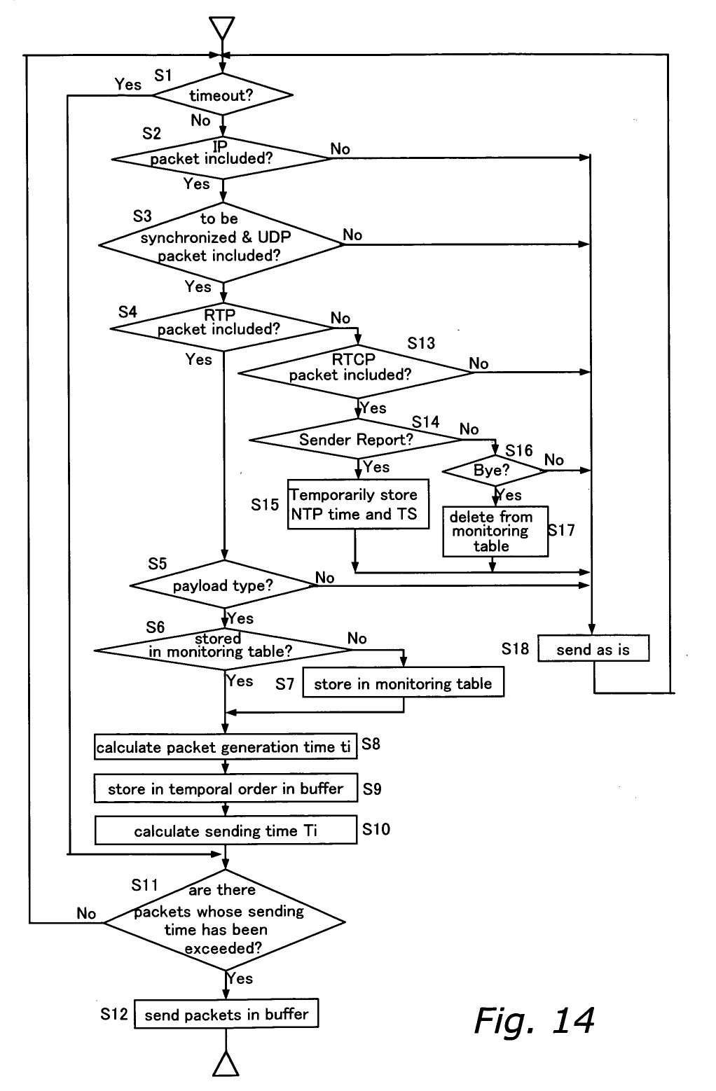

FIG. 14 is a flowchart showing an example of the flow of the synchronization process performed by the synchronization device 10 shown in FIG. 2. This process begins when data arrive at the network card 11a of the synchronization node 1.

Step S1: The filtering module 104 of the synchronization device 10 judges whether a timer has timed out or not. That is to say, it judges whether a predetermined time has passed after the previous packet has been received and before the next packet is received. If “Yes,” then the procedure advances to Step S11 (described below) and if “No,” then the procedure advances to Step S2.

Step S2: The ether filter 104a judges whether the received ether frame includes an IP packet or not. If “Yes,” then the procedure advances to Step S3. If “No,” then the received ether frame is sent out directly to the receiver-side network 4b (see S18 below).

Step S3: The IP filter 104b judges whether a UDP packet is included in the ether frame received from the ether filter 104a. It also judges whether the ether frame from the ether filter 104a is part of a data flow to be synchronized, as set in the settings file 102. If it is judged that both conditions are satisfied, then the procedure advances to Step S4. If the result is “No,” then the received ether frames is sent out directly to the receiver-side network 4b (S18).

Step S4: The RTP filter 104c judges whether the ether frame received from the IP filter 104b includes an RTP packet. If “Yes,” then the procedure advances to Step S5, and if “No,” then the procedure advances to Step S13 (described below).

Step S5: The payload filter 104d judges whether the payload type of the data included in the ether frame received from the RTP filter 104c matches the payload type that is set in the settings file 102. If “Yes,” then the procedure advances to Step S6. If “No,” then the received ether frame is sent out directly to the receiver-side network 4b (S18).

Step S6, S7: The session managing module 103 judges whether the data flow including the received ether frame is stored in the monitoring table 111 (S6). If it is not yet stored therein, then the source IP address and its port number as listed in the IP header of the received ether frame are stored in the monitoring table 111 (S7).

Step S8: The generation time calculation module 106 calculates the time ti at which the RTP packet in the ether frame received from the filtering module 104 was generated by the sending terminal 2.

Step S9: The sorting module 107 receives the generation time ti of the RTP packet included in the ether frame and stores that ether frame in the buffer 108, together with data indicating the generation time order.

Step S10: The sending time calculation module 109 calculates the sending time of the ether frames stored in the buffer 108, and writes the sending time Ti into the buffer 108, in association with the ether frames.

Steps S11 and S12: The extraction module 110 looks up the time shown by an internal clock in the synchronization node 1 and the sending time of the ether frames in the buffer 108, and judges whether there are ether frames in the buffer 108 for which the sending time has already been exceeded (S11). If “Yes,” then those packets are sent out from the raw socket 101b to the receiver-side network 4b (S12). If “No,” then the procedure returns to Step S1 and the same process is carried out again.

Step S13: If the ether frame that has been passed on to the RTP filter 104c in the filtering module 104 includes an RTCP packet, then the procedure advances to Step S14. If neither an RTP packet nor an RTCP packet is included, then that ether frame is sent out directly to the receiver-side network 4b (S18).

Steps S14 and S15: The RTP filter 104c judges whether a Sender Report command is included in the received RTCP packet (S14). If a Sender Report command is included, then the NTP time and the timestamp listed in the RTCP packet are passed on to the generation time calculation module 106. The generation time calculation module 106 temporarily stores these values (S15). The stored values are used for the previously described calculation of the generation time.

Steps S16, S17 and S18: The RTP filter 104c judges whether a Bye command is included in the RTCP packet. If a Bye command is included, then this indicates that the sender wants to terminate the communication with this data flow. Thus, the corresponding data flow is deleted from the entries in the monitoring table 111 (S17). Moreover, the ether frame including this command is sent directly to the receiver-side network (S18).

With the above-described process, a plurality of data flows become synchronized at the synchronization node 1, and are sent out to the receiving terminals 3. Consequently, it is not necessary to perform a synchronization process at the receiving terminals 3. If there are a plurality of receiving terminals 3, then the output results that are output by the various receiving terminals 3 can be synchronized.

### Second Embodiment

(1) Overall Configuration

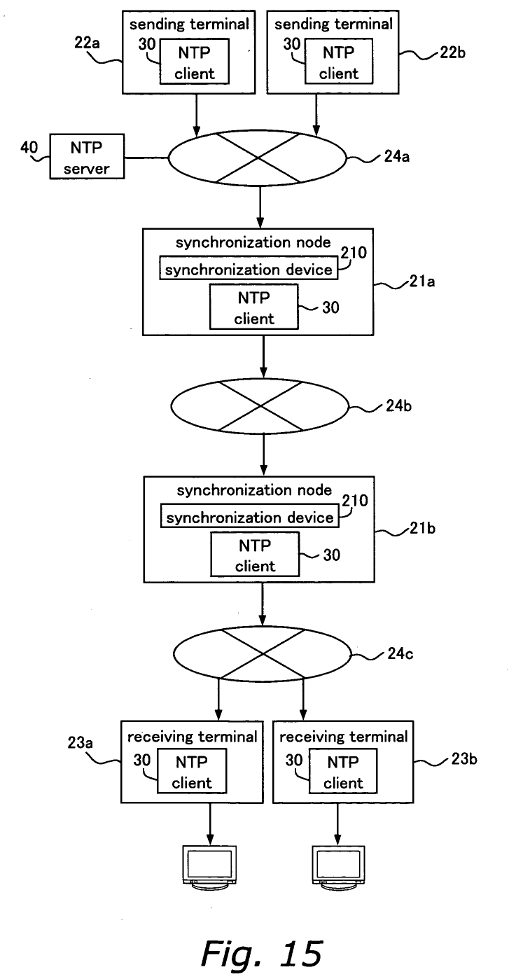

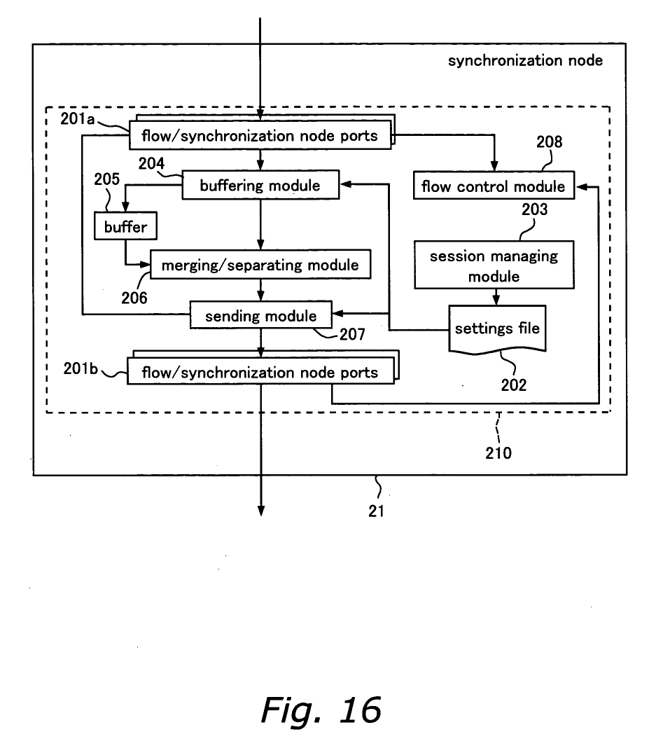

FIG. 15 is a diagram showing the overall configuration of a synchronization system according to a second embodiment. This synchronization system is operated with a receiver-side synchronization node 21a and a sender-side synchronization node 21b. The synchronization nodes 21a and 21b, which are realized by computers, are each provided with a synchronization device 210. A plurality of data flows sent from one or more sending terminals 22a and 22b (referred to as “sending terminals 22” below) are sent via a network 24a to a synchronization node 21a. The synchronization node 21a merges the plurality of data flows and sends them via the network 24b to the synchronization node 21b. The synchronization node 21b restores the original data flows from the merged data flows, and sends them via a network 24c to one ore more receiving terminals 23a and 23b (referred to as “receiving terminals 23” below). It should be noted that to facilitate explanations, the networks 24a to 24c are rendered separately in FIG. 15, but they may also be the same network.

An NTP server 40 is connected to one of the networks 4 (network 24a in FIG. 1). The synchronization nodes 21a and 21b, the sending terminals 22 and the receiving terminals 23 are each provided with an NTP client 30. The NTP server 40 and the NTP clients 30 correct discrepancies between the internal clocks of the synchronization nodes 21, the sending terminals 22 and the receiving terminals 23.

(2) Synchronization Devices

(2-1) The Synchronization Device at the Receiver-Side Synchronization Node

In order to simplify explanations, the following example is for the case that the data flows are sent by UDP and RTP. FIG. 16 is a functional block diagram of the synchronization device 210 provided in the synchronization nodes 21a and 21b. The synchronization device 210 can let a computer function as the receiver-side synchronization node 21a or it can let a computer function as the sender-side synchronization node 21b. First, the synchronization device 210 is described for the case that it lets a computer function as the receiver-side synchronization node 21a. The synchronization node 21a is connected by network cards that are not shown in the figure to the network 24a and to the network 24b. A plurality of data flows from the sending terminals 22 arrive at one or more flow/synchronization node ports (in this case, flow ports) 201a. Which data flow from which sending terminal 22 arrives at which port is specified in the settings file 202. A buffering module 204 looks up the settings file 202, and receives the IP packets from the ports 201a at which the data flows to be synchronized arrive and stores them in a buffer 205. A merging/separating module 206 looks up the timestamp of the RTP packets included in the IP packets, and merges the packets having the same timestamp into one merged packet. The merged packet is sent out by a sending module 207 from flow/synchronization node ports (in this case, synchronization node ports) 201b to the synchronization node 21b.

(2-2) The Synchronization Device at the Sender-Side Synchronization Node The following is an explanation of a synchronization device 210 for the case that it lets a computer function as the sender-side synchronization node 21a. The merged packets that are sent by the synchronization node 21a arrive at flow/synchronization node ports (in this case, synchronization node ports) 201a of the synchronization node 21b. Which port is a synchronization node port is specified in the settings file 202. The merged packets that have arrived at the synchronization node ports 201a are stored by the buffering module 204 in the buffer 205. The packets stored in the buffer 205 are separated and restored by the merging/separating module 206, and passed on to the sending module 207. The packets that have been separated and restored to their original condition are sent out by the sending module 207 from the flow/synchronization node ports (in this case, flow ports) 201b to the receiving terminals 23. Which packets are sent to which receiving terminals is determined by looking up the settings file 202.

(3) Detailed Explanation of Each Block in the Synchronization Device

(3-1) Settings of Data Flows to be Synchronized

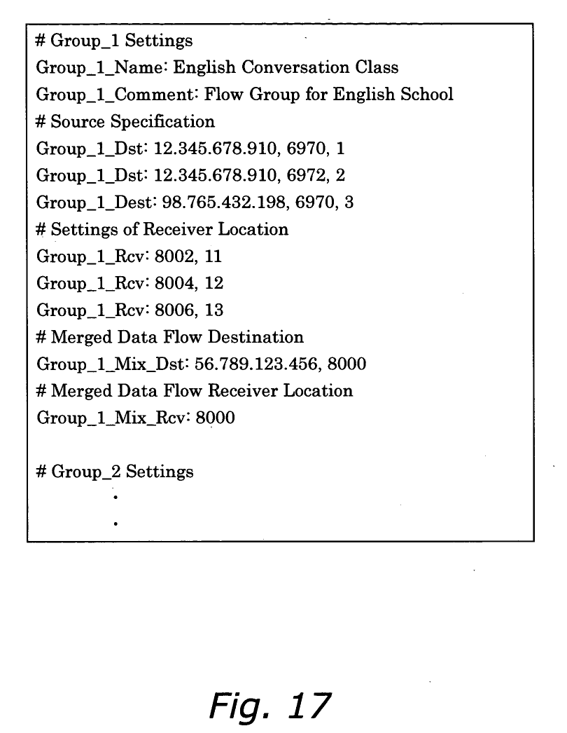

The following is a more detailed explanation of the functions of the various blocks. FIG. 17 is a diagrammatic view of the group specification data listed in the settings file 202. The settings file specifies the data flows to be synchronized. The settings file 202 also lists the various senders and destinations of the data flows to be synchronized. The data flows to be synchronized form one flow group. The synchronization device 210 looks up the settings file 202, and sends to the synchronization node 21b the data that have been sent from the sending terminals 22 to the synchronization node 21a. Moreover, the synchronization device 210 looks up the settings file 202, and sends from the synchronization node 21b to the receiving terminals 23 the data that have been sent from the synchronization node 21a to the synchronization node 21b. In the example in FIG. 17, the following group specification data are specified in the settings file:

(a) “group name” of the flow group

(b) “comments” regarding the group

(c) “address settings”

An “address” is the address of the data flows that have been separated and restored by the synchronization device, in the case that the synchronization device lets a computer function as a sender-side synchronization node. The address is specified with the IP address, port number and flow ID of the receiving terminals. Here, a “flow ID” is identification information that identifies each data stream. In the sender-side synchronization node, the flow ID is used to associate the separated data flows with the addressee terminals. Or, the flow ID may be used for example to identify the individual data flows of the same payload type that are sent and received over the same port. The flow ID is shared by the sending terminals, the synchronization nodes and the receiving terminals. The flow ID may be set by the administrator of the synchronization system, for example.

(d) “Settings of the Receiver Location”

If the synchronization device lets a computer function as a receiver-side synchronization node, then the “receiver location” is specified by the port number for receiving the data flows and the flow ID of the received data flow.

(e) “Address of Merged Data Flow”

If the synchronization device lets a computer function as a receiver-side synchronization node, then the address of the merged data flow is the address to which the merged packets are sent. The address is specified by the IP address and the port number of the sender-side synchronization node 21b that receives the merged packets.

(f) “Receiver Location of Merged Data Flow”

If the synchronization device lets a computer function as a sender-side synchronization node, then the receiver location of the merged data flow is specified by the port number receiving the merged packets sent from the receiver-side synchronization node 21a.

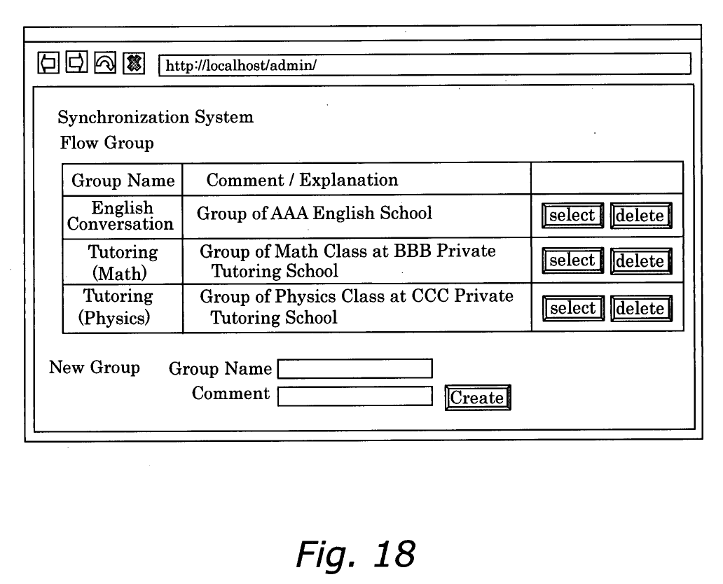

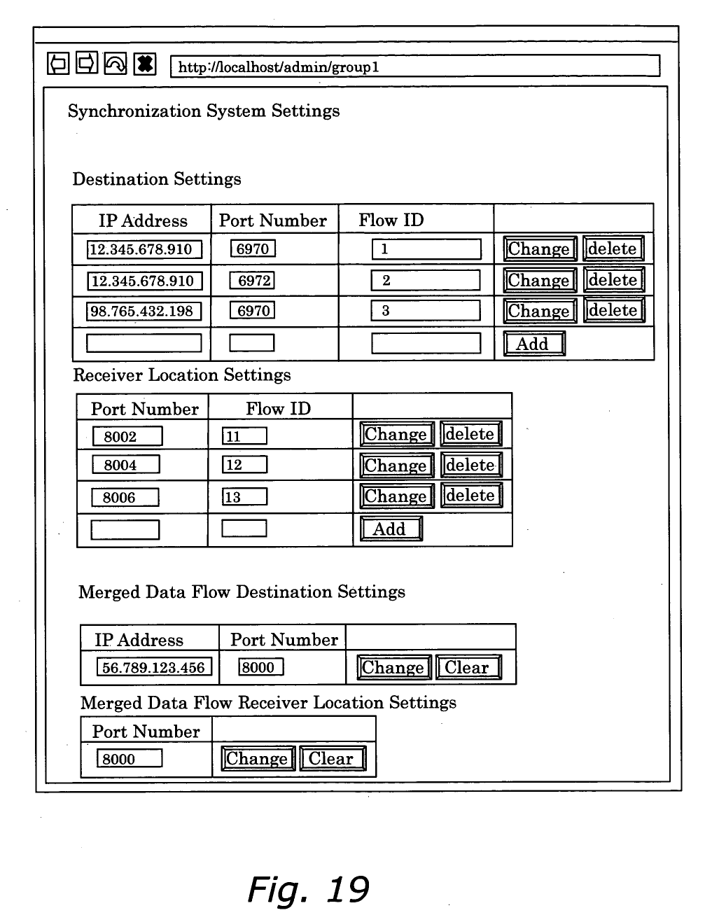

FIGS. 18 and 19 are examples of screens displayed when storing the group specification data to the settings file. These screen examples are displayed by a session managing module 203 on a screen of a display connected to the synchronization nodes 21a and 21b. The information that is input is written into the settings file 202. FIG. 18 is an example of a group selection screen for setting a flow group. In this screen the settings regarding the group name of the flow group and the comments are entered. FIG. 19 is an example of a screen for setting the flows to be synchronized. In this screen, the settings for the address, the receiver location, the merged data flow address, and the merged data flow receiver location are entered for each flow group.

(3-2) Configuration of Merged Packets

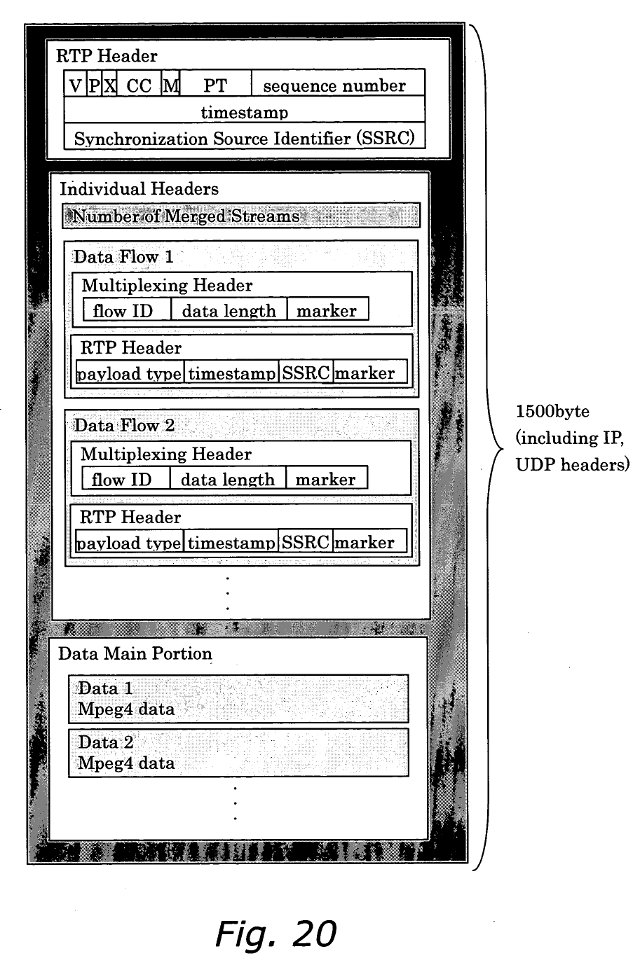

FIG. 20 is a diagram showing the configuration of a portion of a merged packet that is created and separated by the merging/separating module 206. The merged packet is sent and received as the IP data of the IP packet included in the ether frame. The configuration of the ether frame and the IP packets is the same as in FIGS. 7 and 8. The merged packet includes an RTP header, individual headers and the data main portion.

The RTP header has the same configuration as the RTP header of an RTP packet as shown in the previous figures. The field SSRC in the RTP header lists the SSRC of the synchronization node that has generated the merged packet.

The number of the individual headers generated corresponds to the number of merged data flows. The individual headers include a multiplexing header and an RTP header. The multiplexing header includes a flow ID, a data length and a marker. “Data length” is the byte number of the data (data 1, data 2) related to the corresponding flow included in the data main portion. The “marker” indicates whether the merged packet is one for which one frame has been divided and whether it is the last packet of a divided frame. The RTP headers in the individual headers are generated by the sending terminals 22. Those RTP headers include payload type, timestamp, SSRC and marker. Here, “SSRC” is the SSRC of the sending terminal that has sent the data flow. It should be noted that if one frame is sent out divided into a plurality of merged packets, the RTP headers within the individual headers are only necessary for the first merged packet.

The data main portion contains multimedia data, such as audio data and video data or haptic data or the like. The data may also be compressed.

(3-3) Creation and Separation of Merged Packets

The creation and the separation of the merged packets as shown in FIG. 20 is carried out by the merging/separating module 206. The RTP packets that are merged into one merged packet all have the same timestamp. The timestamp depends on the sending interval of the packets, and the sending interval depends on the payload type. Consequently, it is preferable that the data flows merged into the merged packet have the same payload type.

If the data flows to be synchronized include image data, then the creation and separation of the merged packets is carried out frame by frame. That is to say, when a merged packet is generated, the merging/separating module 206 waits until the packets for one frame of the image data flow have been stored in the buffer 205. Then, it is confirmed whether all packets of the other data flows corresponding to that one frame have been received. If for all data flows the packets corresponding to that one frame have been received, then they are merged into a merged packet. If the data size of the data main portion of the merged packet is too large, then that one frame is divided into a plurality of merged packets.

Conversely, when a merged packet is separated, the marker in the multiplexing header is looked up, and it is judged whether one frame has been divided. If there is a division, then all merged packets of one frame are stored in the buffer 205. More specifically, if the value of the marker is “0,” that is, if there is a division, then the merged packets are stored in the buffer 205 until the value of the marker is “1,” that is, until the last merged packet of the divided frame. After that, the merged packets for one frame are separated to retrieve the plurality of RTP packets, and the ether frames including the RTP packets are sent to the receiving terminals 23 receiving the data flows.

The flow control module 208 looks up the flow/synchronization node ports 201a and 201b, and supervises packet loss and RTP communication.

(4) The Process Flow Performed by the Synchronization Device

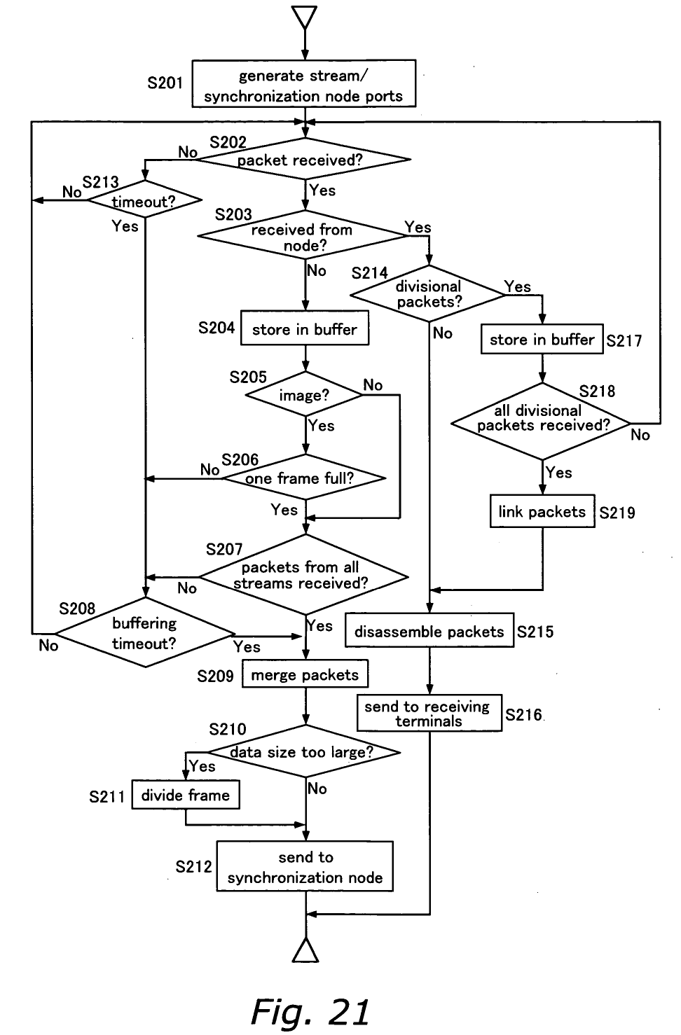

FIG. 21 is a flowchart showing an example of the flow of the synchronization process performed by the synchronization device 10 shown in FIG. 16. This process begins when the synchronization node 21 is started up.

Step S201: First, the synchronization device 210 looks up the settings file 202 and generates the data flow ports and/or synchronization node ports 201a and 201b.

Step S202: The buffering module 204 judges whether a packet has been received from the flow ports or synchronization node ports 201a. If “Yes,” then the procedure advances to Step S203. If “No,” then the procedure advances to the later-described Step S213.

Step S203: The buffering module 204 judges whether the port that has received a packet is a port for merged packets from another synchronization node or whether it is a port for a data flow from a sending terminal. If a data flow is received, then the procedure advances to Step S204. If a merged packet from another synchronization node is received, then the procedure advances to the later-described Step S214.

Steps S204 to S213 are the process that is performed when the synchronization device 210 lets a computer act as a receiver-side synchronization node 21a.

Steps S204 to S207: The buffering module 204 stores the packet received from the sending terminals 22 in the buffer 205 (S204). The merging/separating module 206 judges whether the data main portion in the packet stored in the buffer 205 contains image data (S205). If it contains image data, then it is judged whether all of the data constituting one frame has been gathered in the buffer 205 (S206). Then, it is judged whether the packets from the other data flows corresponding to this one frame have been gathered (S207). That is to say, it is judged whether, for the packets of the other data flows belonging to the same flow group as the data flow of the image data, all the packets having the same timestamp as the image data constituting that one frame have been gathered or not. If “Yes,” then the procedure advances to Step S209. If “No,” then the procedure advances to Step S208.

Step S208: The merging/separating module 206 waits until the packets for one frame have been gathered for all data flows in the flow group. If the waiting time reaches a predetermined upper limit, then the procedure advances to Step S209.

Step S209: The merging/separating module 206 merges the packets in the buffer 205 and generates a merged packet.

Steps S210 and S211: The merging/separating module 206 judges whether the data size of the merged packet is too large and the merged packet needs to be divided into a plurality of packets (S210). If “Yes,” then the merged packet is divided into a plurality of packets (S211).

Step S212: The sending module 207 sends the merged packet from a synchronization node port 201b to a specified port of the sender-side synchronization node 21b.

Step S213: If no packets arrive from the sending terminals 22 at the buffering module 204 for at least a predetermined time, then the procedure advances to Step S208.

Steps S214 to S219 are the process that is performed when the synchronization device 210 lets a computer act as a sender-side synchronization node 21b.

Steps S214 to S216: If a merged packet is received from a synchronization node, then the merging/ separating module 206 looks up the individual headers of the merged packet, and judges whether one frame has been divided into a plurality of merged packets. If there is no division, then the received merged packet is separated, and the packets are restored for each data flow (S215) and sent to the receiving terminals receiving those data flows (S216).

Steps S217 to S219: If the received merged packet has been divided, then the buffering module 204 stores the received merged packet in the buffer 205 (S217). Then, the merging/separating module 206 judges whether all merged packets constituting one frame have been received or not (S218). If “Yes,” then the merging/separating module 206 links each data flow to the data retrieved from the data main portion of the plurality of merged packets for one frame (S219). In this case, the data with identical flow IDs are linked together. The flow ID of the data in the data main portion can be specified by looking up the individual headers of the merged packets. After that, the merged packets are disassembled and restored as describe above, and sent to the receiver terminals.

With this processing, it is possible to synchronize the output results from the receiver terminals without performing a synchronization process at the receiver terminals.

### Other Embodiments

The scope of the present invention also encompasses a program for executing the above-described synchronization method on a computer, as well as a computer-readable recording medium on which such a program is recorded. Examples of suitable recording media include computer-readable flexible disks, hard-disks, semiconductor memories, CD-ROMs, DVDs and magneto-optical disks (MOs), among others.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. A data synchronization method performed by a computer relaying a plurality of data flows between a plurality of networks, comprising:
a storing step of storing identifiers of a plurality of data flows to be synchronized;
a receiving step of receiving data flows flowing on at least one of the networks;
a selecting step of selecting, from the received data flows, a plurality of the data flows corresponding to the stored identifiers;
a calculating step of calculating times when each packet included in the selected data flows has been generated by one or more sending terminals that have sent the selected data flows;
an order determining step of determining, in accordance with the calculated generation times, an order in which each packet included in the selected data flows is sent to one or more receiving terminals that are the destinations of the selected data flows;
a sending time determining step of determining the sending times of each packet included in the selected data flows, such that intervals between the sending times of the packets are equivalent to intervals between the generation times of the packets and the packets are sent in accordance with said order; and
a sending step of sending each packet to the one or more receiving terminals, based on the sending times.

2. The data synchronization method according to claim 1, wherein in the storing step, a screen for entering settings of the identifiers of the plurality of data flows to be synchronized is displayed, and the identifiers entered in that screen are stored.

3. The data synchronization method according to claim 1, wherein
in the selecting step, a plurality of data flows made of packets are selected, which include packets specifying time data related to times at which the one or more sending terminals sending the data flows have generated the packets; and
in the calculating step, the generation times of the packets are calculated based on the time data.

4. The data synchronization method according to claim 1, wherein in the sending step:
the packet sending times and the packets are temporarily stored in association with each other;
it is judged at a predetermined timing whether there are temporarily stored packets whose sending time have been exceeded; and
the packets whose sending times has been exceeded are sent out.

5. The data synchronization method according to claim 1,
further comprising a buffering step of temporarily storing packets included in the data flows selected in the selecting step;
wherein the calculating step calculates the generation times based on an absolute time and a timestamp specified in an RTCP packet included in the selected data flow as well as a timestamp included in an RTP packet; and
wherein the sending time determining step determines a reference time T0 for determining the sending times based on a time T_{rtcp} at which the first RTCP packet has arrived from one of the sending terminals and a maximum time Tₘₐₓ for which packets can be stored in the buffering step.

6. The data synchronization method according to claim 1,
further comprising a buffering step of temporarily storing packets included in the data flows selected in the selecting step;
wherein the calculating step calculates the generation times based on an absolute time and a timestamp specified in an RTCP packet included in the selected data flow as well as a timestamp included in an RTP packet; and
wherein the sending time determining step determines a reference time T0 for determining the sending times based on a time Tᵣₜₑₚ at which the first RTCP packet has arrived from one of the sending terminals and a time T_{b} that is necessary to store a predetermined amount of packets in the buffering step.

7. A data synchronization system relaying a plurality of data flows between a plurality of networks, comprising:
a storing means for storing identifiers of a plurality of data flows to be synchronized;
a receiving means for receiving data flows flowing on at least one of the networks;
a selecting means for selecting, from the received data flows, a plurality of the data flows corresponding to the stored identifiers;
a calculating means for calculating times when each packet included in the selected data flows has been generated by one or more sending terminals that have sent the selected data flows;
an order determining means for determining, in accordance with the calculated generation times, an order in which each packet included in the selected data flows is sent to one or more receiving terminals that are the destinations of the selected data flows;
a sending time determining means for determining the sending times of each packet included in the selected data flows, such that intervals between the sending times of the packets are equivalent to intervals between the generation times of the packets and the packets are sent in accordance with said order; and
a sending means for sending each packet to the one or more receiving terminals, based on the sending times.

8. A data synchronization program executed on a computer relaying a plurality of data flows between a plurality of networks, comprising:
a storing step of storing identifiers of a plurality of data flows to be synchronized;
a receiving step of receiving data flows flowing on at least one of the networks;
a selecting step of selecting, from the received data flows, a plurality of the data flows corresponding to the stored identifiers;
a calculating step of calculating times when each packet included in the selected data flows has been generated by one or more sending terminals that have sent the selected data flows;
an order determining step of determining, in accordance with the calculated generation times, an order in which each packet included in the selected data flows is sent to one or more receiving terminals that are the destinations of the selected data flows;
a sending time determining step of determining the sending times of each packet included in the selected data flows, such that intervals between the sending times of the packets are equivalent to intervals between the generation times of the packets and the packets are sent in accordance with said order; and
a sending step of sending each packet to the one or more receiving terminals, based on the sending times.

9. A data synchronization method performed by a computer relaying a plurality of data flows between a plurality of networks, comprising:
a receiving step of receiving, from at least one of the networks, a plurality of data flows made of packets, including packets specifying times at which one or more sending terminals sending the data flows have generated the packets;
a storing step of storing identifiers of a plurality of data flows to be synchronized, and a relay address of a relaying device relaying the plurality of data flows;
a selecting step of selecting, from the data flows received in the receiving step, a plurality of the data flows corresponding to the stored identifiers;
a merging step of generating a merged packet in which those packets in the selected data flows that have the same generation time have been merged into one packet; and
a sending step of sending the merged packet to the relay address.

10. The data synchronization method according to claim 9, wherein in the storing step, a screen for entering settings of the identifiers of the plurality of data flows to be synchronized and the relay address of the relaying device is displayed, and the identifiers and the relay address entered in that screen are stored.

11. The data synchronization method according to claim 9, wherein
the storing step further stores a payload type of the respective data flows; and
the merging step merges those packets in the selected data flows that have the same payload type into one packet.

12. A data synchronization system relaying a plurality of data flows between a plurality of networks, comprising:
a receiving means for receiving, from at least one of the networks, a plurality of data flows made of packets, including packets specifying times at which one or more sending terminals sending the data flows have generated the packets;
a storing means for storing identifiers of a plurality of data flows to be synchronized, and a relay address of a relaying device relaying the plurality of data flows;
a selecting means for selecting, from the data flows received with the receiving means, a plurality of the data flows corresponding to the stored identifiers;
a merging means for generating a merged packet in which those packets in the selected data flows that have the same generation time have been merged into one packet; and
a sending means for sending the merged packet to the relay address.

13. A data synchronization program executed by a computer relaying a plurality of data flows between a plurality of networks, comprising:
a receiving step of receiving, from at least one of the networks, a plurality of data flows made of packets, including packets specifying times at which one or more sending terminals sending the data flows have generated the packets;
a storing step of storing identifiers of a plurality of data flows to be synchronized, and a relay address of a relaying device relaying the plurality of data flows;
a selecting step of selecting, from the data flows received in the receiving step, a plurality of the data flows corresponding to the stored identifiers;
a merging step of generating a merged packet in which those packets in the selected data flows that have the same generation time have been merged into one packet; and
a sending step of sending the merged packet to the relay address.

14. A data synchronization method performed by a computer relaying a plurality of data flows between a plurality of networks, comprising:
a receiving step of receiving, from at least one of the networks, a merged packet generated by the method according to claim 9;
a storing step of storing the destination addresses of the data flows included in the merged data flow including the merged packet;
a disassembling step of disassembling the merged packet and restoring the plurality of data flows; and
a sending step of sending the restored plurality of data flows to their respective destination addresses.

15. The data synchronization method according to claim 14, wherein in the storing step, a screen for entering settings of identifiers of a receiver location of the merged data flow and the respective destination addresses of the data flows is displayed, and the identifier and destination addresses entered in that screen are stored.

16. A data synchronization system relaying a plurality of data flows between a plurality of networks, comprising:
a receiving means for receiving, from at least one of the networks, a merged packet generated by the method according to claim 9;
a storing means for storing the destination addresses of the data flows included in the merged data flow including the merged packet;
a disassembling means for disassembling the merged packet and restoring the plurality of data flows; and
a sending means for sending the restored plurality of data flows to their respective destination addresses.

17. A data synchronization program executed by a computer relaying a plurality of data flows between a plurality of networks, comprising:
a receiving step of receiving, from at least one of the networks, a merged packet generated by the method according to claim 9;
a storing step of storing the destination addresses of the data flows included in the merged data flow including the merged packet;
a disassembling step of disassembling the merged packet and restoring the plurality of data flows; and
a sending step of sending the restored plurality of data flows to their respective destination addresses.
